(19) United States
(12) Patent Application Publication
(10) Pub. No.: US 2019/0381912 A1
(43) Pub. Date: Dec. 19, 2019

(54) TECHNIQUE FOR THE HEAT-UP OF A TRACTION ENERGY STORE

(71) Applicant: MAN Truck & Bus SE, Munchen (DE)

(72) Inventor: Alexander Schydlo, Munchen (DE)

(21) Appl. No.: 16/442,124

(22) Filed: Jun. 14, 2019

(30) Foreign Application Priority Data
Jun. 15, 2018 (DE) 10 2018 114 417.2

(51) Int. Cl. B60L 58/27; H01M 10/625; H01M 10/615; H01M 10/6552; H01M 10/6569; H01M 10/42; H01M 10/48; H01M 10/63

(52) U.S. Cl. CPC B60L 58/27; H01M 10/625; H01M 10/615; H01M 10/6552; B60K 6/28; H01M 10/425; H01M 10/486; H01M 10/63; H01M 10/6569

(57) ABSTRACT

A traction energy store for the storage of electrical energy in a motor vehicle which is propelled or propellable by means of the stored energy is described. The traction energy store comprises at least one electrochemical secondary cell, respectively comprising at least one cell wall. The traction energy store further comprises at least one pressure-tight heat pipe, which is configured for the passive transmission of heat from a heat-absorbing end of the heat pipe to a heat-emitting end of the heat pipe, which heat-emitting end is spaced from the heat-absorbing end, using heat of vaporization. The heat-emitting end constitutes part of the cell wall or projects through the cell wall into the respective secondary cell. The traction energy store further comprises at least one heat source, which is arranged outside the at least one secondary cell and is in direct contact with the heat-absorbing end.

### FIELD

The disclosure relates to a technique for the input of heat to a traction energy store for an electrically powered motor vehicle. In particular, a heatable traction energy store and a motor vehicle equipped with same are described.

### BACKGROUND

The traction energy store of an electrically powered motor vehicle, for example a hybrid electric vehicle (HEV) or a battery electric vehicle (BEV) requires a specific operating temperature range, or a minimum operating temperature, in order to be able to ensure the maintenance of the optimum operating state of the traction energy store. The temperature of the traction energy store influences its charging capacity, efficiency and service life. Depending upon the ambient temperature, for example of a motor vehicle which is parked up in winter, a temperature increase may be necessary during or prior to the use of the traction energy store.

According to existing technical concepts, it is provided that, during cold winter months, the battery cells of the traction energy store are heated by means of a coolant. Document US 2009/0249807 A1 describes an optional heating arrangement of this type, wherein the coolant flowing through the traction energy store is circulated in a secondary circuit.

A disadvantage of the existing technical concepts is the efficiency of the overall system. Of the electrical energy which is stored chemically in the traction energy store, a proportion must be employed for temperature management, namely to overcome the high thermal resistance associated with the convective heat exchanger on the traction energy store and with the coolant circuit. Moreover, it is necessary to drive a circulation pump for the conveyance of the coolant.

### SUMMARY

A resulting object is therefore the minimization of exergy losses in temperature management circuits of a traction energy store. An alternative or supplementary object is the more rapid and/or more spatially uniform heat-up of a traction energy store in order to achieve a minimum temperature.

This object or these objects are achieved by a technique having the features described in greater detail in the following description, with partial reference to the figures.

According to one aspect, a traction energy store for the storage of electrical energy in a motor vehicle which is propelled or propellable by means of the stored energy is provided. The traction energy store can comprise at least one electrochemical secondary cell, respectively comprising at least one cell wall. Alternatively or additionally, the traction energy store can comprise at least one (for example, pressure-tight) heat pipe. The heat pipe can be configured for the passive transmission of heat from a heat-absorbing end of the heat pipe to a heat-emitting end of the heat pipe, which heat-emitting end is spaced from the heat-absorbing end, using heat of vaporization. The heat-emitting end can constitute part of the cell wall and/or project through the cell wall into the respective secondary cell. Alternatively or additionally, the traction energy store can comprise at least one heat source, which is arranged outside the at least one secondary cell. The at least one heat source can be in direct contact with the respective heat-absorbing end.

By means of the heat pipe, heat from outside the secondary cells can be rapidly introduced into the respective secondary cell with limited exergy losses. Alternatively or additionally, by means of the heat of vaporization, latent heat associated with the transition from a liquid to a gaseous aggregate state of a coolant which is enclosed in the pressure-tight heat pipe can be delivered to the respective secondary cell of the traction energy store. High resistance to thermal conduction, as occurs with a conventional convective heat exchanger on the traction energy store, can be eliminated or reduced by the direct thermal contact between the heat pipe and the secondary cell.

The traction energy store can also be described as a battery unit or a battery module.

The traction energy store can further comprise a control unit (for example a battery management system), which is configured to optionally operate the heat source depending upon the symbol of a difference between a stipulated target temperature and a detected actual temperature of the secondary cell. Optionally, the control unit can consider a heat input from the heat pipe to the secondary cell and/or a heat input associated with the power tap-off on the secondary cell for the supply of current to the heat source, for the purposes of temperature control of the secondary cell.

A boiling point of the coolant enclosed in the heat pipe can be tailored to the minimum operating temperature of the traction energy store. For example, the boiling point can be lower than the minimum operating temperature.

The electrochemical secondary cell (also: secondary cell or cell) can be configured for the electrochemical storage of the energy, or a proportion of the energy. Each cell can respectively comprise a pair of spatially separated electrodes and an electrolyte a for the conduction of ions. The at least one cell wall can spatially delimit the electrodes and/or the electrolyte.

The heat-emitting end can be in direct thermal contact with an electrolyte in the respective secondary cell. For example, the heat-emitting end can be enclosed by the electrolyte of the respective secondary cell.

The heat-emitting end can pass through the respective secondary cell. Alternatively or additionally, the cell wall of the respective secondary cell and the heat-emitting end of the respective heat pipe can be integrally configured in a one-piece arrangement.

The heat-absorbing end of the at least one heat pipe can be electrically conductive. The heat source can be arranged to drive an electric heating current at the heat-absorbing end. Alternatively or additionally, the heat-absorbing end can be inductively heated or heatable by the heat source. The electric heating current can be an eddy current.

The traction energy store can comprise a plurality of secondary cells. At least one of the heat pipes can be assigned to each of the secondary cells. The plurality of secondary cells can be arranged in a housing. The heat source can be arranged on the housing (for example on the exterior).

The traction energy store can further comprise a battery management system (BMS). The BMS can be configured to detect a temperature of the at least one secondary cell and, depending upon the detected temperature, to control a current fed from the at least one secondary cell of the heat source.

The heat source can comprise an electrically operated heating cartridge and/or an electrically operated heating foil.

The traction energy store can further comprise an electric power terminal, which establishes, or can be configured for the establishment of, an energy exchange with an electric drive train of the motor vehicle.

According to a further aspect, a motor vehicle, in particular a service vehicle, is provided. The motor vehicle comprises a traction energy store according to one exemplary embodiment of the above-mentioned aspect. The service vehicle can be an HGV, a tractor or a bus. Further aspects of the invention relate to a method for the heat-up of a traction energy store, involving process steps corresponding to the above-mentioned device features and/or the provision of the above-mentioned device features, and to a method for producing such a traction energy store.

### BRIEF DESCRIPTION OF THE DRAWINGS

Further features and advantages of the invention are described hereinafter with reference to the attached drawings, in which:

FIG. 1 shows a schematic block diagram of a conventional device for the temperature control of a traction energy store;

FIG. 2 shows a schematic block diagram of a first exemplary embodiment of a traction energy store;

FIG. 3 shows a schematic perspective view of a second exemplary embodiment of a traction energy store;

FIG. 4 shows a schematic sectional view of the second exemplary embodiment of the traction energy store; and

FIG. 5 shows a schematic perspective view of a third exemplary embodiment of a traction energy store.

### DETAILED DESCRIPTION

A traction energy store, which can also be described as a battery unit, requires an optimum operating temperature, in order to be able to ensure the maintenance of the optimum operating state. The operating temperature influences the efficiency and the service life of the traction energy store.

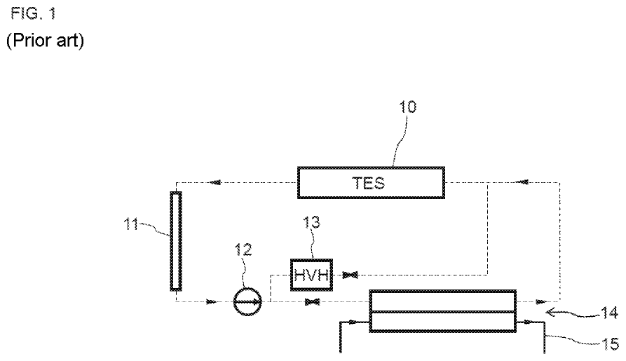

FIG. 1 shows as a comparative example a schematic block diagram of a conventional device for the temperature control of a traction energy store 10. The conventional device comprises an electrical high-voltage heater (HVH) 13, which is incorporated in a coolant circuit. Depending upon the ambient temperature and the temperature of the traction energy store 10, the HVH 13 is optionally switched on. The thermal flux generated by the HVH 13 is transmitted to the coolant in an HVH heat exchanger and, by means of heat transfer mechanisms, including convection and thermal conduction, is transferred from the mass stream of the coolant to the traction energy store 10. As a result of this multi-stage heat transfer (in particular by means of multi-stage energy transformations), exergy losses occur which reduce the efficiency of the overall system and lead to an increase in the energy consumption of the overall system.

Whereas exemplary embodiments of the invention can optionally retain the coolant circuit for the cooling of the traction energy store 10, the exemplary embodiments permit a more rapid and/or more efficient transfer of heat. In particular, the offshoot of the HVH 13 in the coolant circuit can be omitted.

Exemplary embodiments can incorporate the technique for the heat-up of the traction energy store 10 in the latter.

Optionally, each exemplary embodiment of the traction energy store can be integrated in a coolant circuit, which comprises a radiator 11, a circulation pump 12 and a refrigerator 14. The traction energy store can be arranged in the coolant circuit, downstream of the refrigerator 14 and upstream of the radiator 11.

The refrigerator 14 can incorporate a refrigerant circuit 15 which, by means of a heat exchanger, exchanges heat with the coolant circuit of the traction energy store 10. The heat exchanger of the refrigerator 14 can be connected, on its input side, to a thermal expansion valve and, on its output side, to a compressor.

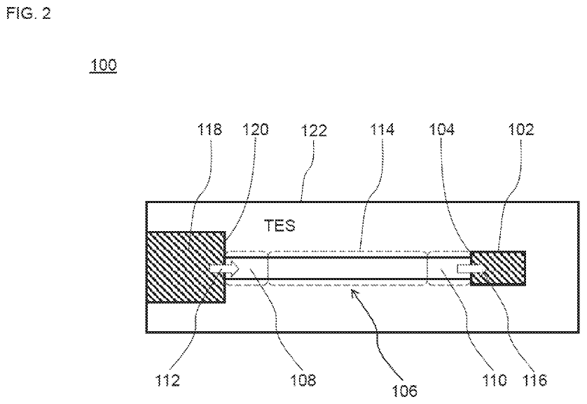

FIG. 2 shows a schematic block diagram of a first exemplary embodiment of a traction energy store which is generally identified by the reference number 100. Each exemplary embodiment of the traction energy store 100, for example by the omission of the offshoot of the HVH 13, can be employed in the coolant circuit identified in FIG. 1 by reference number 10.

The traction energy store 100 is configured for the storage of electrical energy in a motor vehicle which is propelled or propellable by means of the stored energy. The traction energy store 100 comprises at least one electrochemical secondary cell 102, respectively comprising at least one cell wall 104. The traction energy store 100 further comprises at least one pressure-tight heat pipe 106, which is configured for the passive transmission of heat from a heat-absorbing end 108 of the heat pipe 106 to a heat-emitting end 110 of the heat pipe 106, which heat-emitting end 110 is spaced from the heat-absorbing end 108, using heat of vaporization. The heat-emitting end 110 constitutes part of the cell wall 104 or projects through the cell wall 104 into the respective secondary cell 102.

A coolant is contained in the pressure-tight heat pipe 106. The heat-absorbing end 108 functions as a coolant vaporizer, wherein the latent heat is introduced by thermal conduction 112, or inductively. Via an adiabatic zone 114 of the heat pipe 106, the introduced heat in to the interior of the traction energy store 100 is transferred to the at least one secondary cell 102. At the heat-emitting end 110, the transferred heat is delivered to the respective secondary cell 102. The heat-emitting end 110 functions here as a condenser for the coolant contained in the heat pipe 106.

The traction energy store 100 comprises at least one heat source 118, which is arranged outside the at least one secondary cell 102 and is in direct contact 120 with the heat-absorbing end 108. The direct contact 120 can be achieved by means of direct thermal contact for thermal conduction, or by means of an electromagnetic near field for the induction of eddy currents at the heat-absorbing end 108.

All secondary cells 102 can be arranged in a housing 122. The heat source 118 can be attached to the housing 122 (for example, on the interior or the exterior).

The electric power supply for the circulation pump 12, upon the heat-up of the traction energy store, can thus be omitted. This means that, in comparison with conventional heating by means of the conventional HVH 13, no additional electrical operating energy must be employed for the circulation pump upon the heat-up of the traction energy store 100. This conventional operating power of the electric circulation pump 12 is dependent upon the internal pressure losses in the coolant circuit and upon the efficiency of the circulation pump 12. As a result, the exergy loss can be reduced and the number of energy transformation stages in the heating circuit minimized. In particular, the efficiency of the overall system can be increased and the energy consumption thereof reduced.

Each exemplary embodiment of the traction energy store 100 can be employable in hybrid electric vehicles (HEV) or battery electric vehicles (BEV).

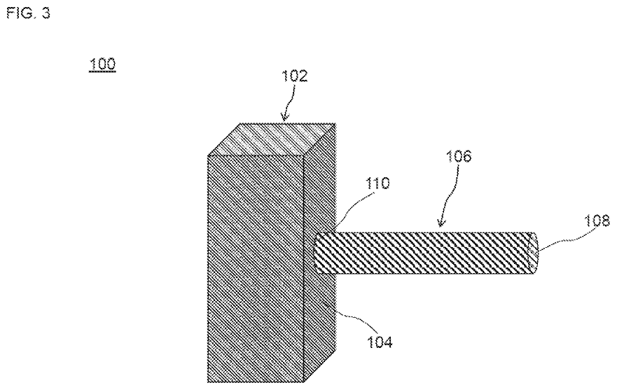

FIG. 3 shows a schematic perspective view of a second exemplary embodiment of a traction energy store 100. The second exemplary embodiment can be configured as a further development of the first exemplary embodiment. For example, one or more of the features described with reference to FIG. 3 can supplement or replace a corresponding or alterative feature in the first exemplary embodiment represented in FIG. 2. To this end, interchangeable or equivalent features are provided with the same reference numbers.

The heat pipe 106 is integrated with its heat-emitting end 110 in the secondary cell 102. For example, a gas-tight enclosure of the heat pipe 106 and the cell wall 104 of the secondary cell 102 facing the heat pipe 106 can be integrally configured in a one-piece arrangement, for example of the same metallic material. As a result, in addition to a virtually exergy-sustaining heat transfer within the heat pipe 106, associated with the adiabatic zone 114, the exergy loss associated with the thermal conduction 116 at the heat-emitting end 110 can also be minimized.

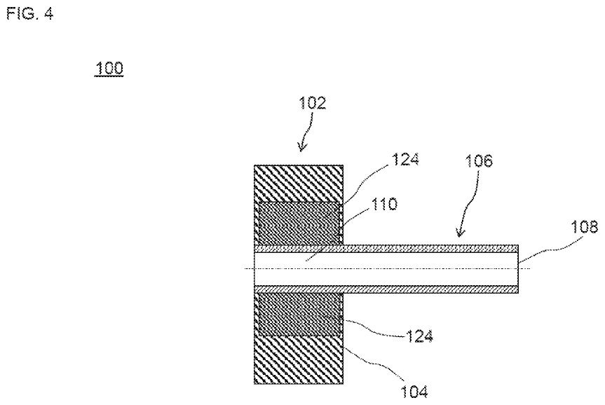

FIG. 4 shows a schematic sectional view of one exemplary embodiment, for example of the second exemplary embodiment of FIG. 3. The section plane represented encompasses a longitudinal axis of the heat pipe 106, and is parallel thereto.

The heat pipe 106, at least with its heat-emitting end 110, is incorporated in the individual secondary cell 102 (which can also be described as battery cell). The heat-emitting end 110 projects through the cell wall 104 into the interior of the secondary cell 102. Preferably, the heat pipe 106 passes through the secondary cell 102. This means that the heat-emitting end 110 extends from the cell wall 104 through which the heat pipe 106 passes through to the cell wall of the secondary cell 102 which lies opposite the cell wall 104.

The heat-emitting end 110 of the heat pipe 106 which projects into the secondary cell 102 is in direct thermal contact with an electrolyte 124 in the interior of the secondary cell 102. By means of the direct thermal connection integrated in the secondary cell 102, a large heat transfer surface for thermal conduction 116 is provided and permits a more efficient and more rapid heat transfer.

In each of the above-mentioned exemplary embodiments, the number of heat pipes 106 and/or the capacity thereof (for example, the diameter thereof) for heat transfer is variable, in particular according to an arrangement structure and/or a density of the secondary cells 102 arranged in the traction energy store 100.

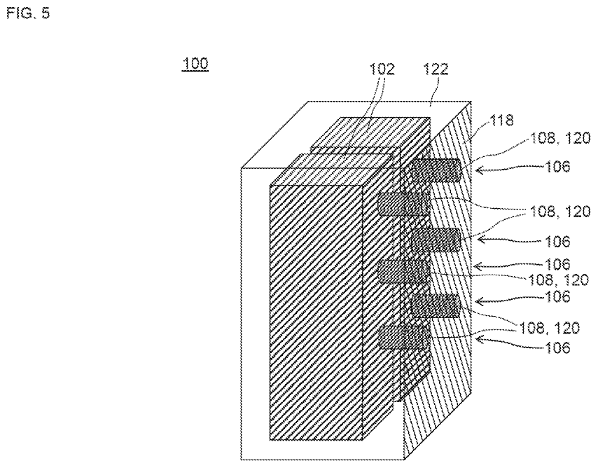

FIG. 5 shows a third exemplary embodiment of the traction energy store 100. The traction energy store 100 comprises at least two electrochemical secondary cells 102 in a housing 122. Each secondary cell 102, for the purposes of heat transfer, by means of one or more heat pipes 106 (in the third exemplary embodiment represented in FIG. 5, for example, by means of three heat pipes 106 respectively), is connected to a heat source 118 arranged on the housing 122.

In the exemplary embodiment represented in FIG. 5, the heat source 118 comprises a heating foil which is directly adhesively bonded to the traction energy store 100 (more in particular: to at least one surface of the housing 122). Heat transfer from the heating foil 118 through the contact surface of the respective heat-absorbing ends 108 of the heat pipes 106 into the respective secondary cells 102 is thus energy-efficient. Moreover, an electrical short-circuit or leakage currents between the electrical heat source 118 and the electrochemical reactions within the individual secondary cells 102 can be excluded by the spatial separation associated with the heat pipes 106.

Each exemplary embodiment can permit an indirect heat transfer between a heat source 118 (for example a heating element) and a heat sink (for example a secondary cell 102) in the traction energy store 100 (for example in a battery unit) by means of one or more heat pipes. The thermal flux from the heat source 118 can be transferred to the coolant in the heat pipe 106 by direct contact 120 with the at least one heat pipe 106, for example by means of a contact surface or by electrical induction. By the vaporization of the coolant at the heat-absorbing end 108 and condensation at the heat-emitting end 110, a sensible thermal flux and a latent thermal flux are delivered on the secondary cell 102 (i.e. the heat sink) by heat transfer from the respective heat pipe 106.

In each heat pipe 106, at the heat-absorbing end 108, the coolant can be vaporized in a vaporization zone, and transmitted in the adiabatic zone 114 by heat transfer and material transfer, in order to condense in a condensation zone at the heat-emitting end 110. Heat transfer between the individual components, i.e. the heat source 118 and the heat pipe 106 (at the heat-absorbing end 108), or between the heat pipe 106 and the secondary cell 102 (at the heat-emitting end 110) can be achieved by means of a thermal conduction mechanism, for example between contact surfaces of the respective solid bodies or within a solid body which is integrally configured in a one-piece arrangement.

Although the invention has been described with reference to functional and structural features for a device aspect, the invention also relates to a corresponding method aspect, in particular a method for producing a traction energy store of this type.

In a method for the indirect heat-up of a traction energy store (for example, without the use of a coolant circuit during heat-up), at least one heat pipe and one heat source can be provided.

The heat-absorbing end of the heat pipe can cooperate, or can be operatively connected, with a heat source, for the absorption of heat. For the transfer of heat to at least one secondary cell of the traction energy store, the heat-emitting end of the heat pipe can cooperate, or can be operatively connected, with the secondary cell.

In each aspect, the at least one heat source 118 can be installed or integrated in or on the traction energy store 100. Examples of the heat source 118 include heating cartridges, heating foils and heating elements. Each heat source 118 can be in thermal contact with one or more heat pipes 106, which function as intermediate heat exchangers, and conduct the thermal flux to the at least one secondary cell 102, by way of a heat sink in the traction energy store 100.

Optionally, heat transfer between the individual components is executed by thermal conduction. Thermal conduction can be a dominant heat transfer mechanism between the heat source 118 and the heated secondary cell 102.

By the indirect heat-up of the secondary cells via the heat pipes, electrical components of the heat source and of the secondary cell can be spatially separated for protection against short-circuits and leakage currents.

By means of the heat-up using directly contacted and/or integrally configured one-piece heat pipes, exergy losses in the heating circuit can be reduced. Alternatively or additionally, by means of this heat-up, the number of energy transformation stages in the heating circuit can be reduced. Accordingly, the indirect heat-up of the secondary cells via the heat pipes can result in the reduction of the energy consumption of the traction energy store as primary energy source. Alternatively or additionally, this heat-up can increase the range of the motor vehicle and/or reduce operating costs of the motor vehicle. Moreover, by the omission of the HVH offshoot, the production costs for an electric drive train can be reduced.

In each exemplary embodiment, a fluid can be contained in the heat pipe in the form of an organic or inorganic coolant.

The method for heat-up and/or each exemplary embodiment of the traction energy store can be implemented in a private car or in a service vehicle (in particular an HGV, a tractor or a bus). The traction energy store can be configured for the electric propulsion of a battery electric vehicle (BEV) and/or a hybrid electric vehicle (HEV).

Although exemplary embodiments have been described, it will be evident to a person skilled in the art that various modifications can be undertaken and equivalents employed by way of substitution. Moreover, numerous modifications can be undertaken in order to adapt a specific situation or a specific material to the teachings of the disclosure. Consequently, the disclosure is not limited to the above-mentioned exemplary embodiments, but encompasses all exemplary embodiments which fall within the scope of protection.

### LIST OF REFERENCE NUMBERS

100 Traction energy store

102 Secondary cell

104 Cell wall of the secondary cell

106 Heat pipe

108 Heat-absorbing end of the heat pipe

110 Heat-emitting end of the heat pipe

112 Thermal conduction from the heat source to the heat pipe

114 Adiabatic zone of the heat pipe

116 Thermal conduction from the heat pipe to the secondary cell

118 Heat source

120 Direct contact between the heat source and the heat-absorbing end

122 Housing of the traction energy store

124 Electrolyte

What is claimed is:

1. A traction energy store for storage of electrical energy in a motor vehicle, which is propelled or propellable using the stored electrical energy, comprising:
at least one electrochemical secondary cell comprising at least one cell wall;
at least one pressure-tight heat pipe, which is configured for passive transmission of heat from a heat-absorbing end of the at least one pressure-tight heat pipe to a heat-emitting end of the at least one pressure-tight heat pipe, wherein the heat-emitting end is spaced from the heat-absorbing end, using heat of vaporization, wherein the heat-emitting end constitutes part of the at least one cell wall or projects through the at least one cell wall into the at least one electrochemical secondary cell; and
at least one heat source arranged outside the at least one electrochemical secondary cell and in direct contact with the heat-absorbing end of the at least one pressure-tight heat pipe.

2. The traction energy store according to claim 1, wherein the heat-emitting end of the at least one pressure-tight heat pipe passes through the at least one electrochemical secondary cell.

3. The traction energy store according to claim 1, wherein the heat-emitting end of the at least one pressure-tight heat pipe is in direct thermal contact with an electrolyte of the at least one electrochemical secondary cell.

4. The traction energy store according to claim 1, wherein the at least one cell wall of the at least one electrochemical secondary cell and the heat-emitting end of the at least one pressure-tight heat pipe are integrally configured in a one-piece arrangement.

5. The traction energy store according to claim 1, wherein the heat-absorbing end of the at least one pressure-tight heat pipe is electrically conductive and the at least one heat source is arranged to drive an electric heating current at the heat-absorbing end of the at least one pressure-tight heat pipe.

6. The traction energy store according to claim 1, wherein the heat-absorbing end of the at least one pressure-tight heat pipe is inductively heated or heatable by the at least one heat source.

7. The traction energy store according to claim 1, wherein at least one of a plurality of pressure-tight heat pipes is respectively assigned to a plurality of electrochemical secondary cells.

8. The traction energy store according to claim 7, wherein the plurality of electrochemical secondary cells are arranged in a housing, and the at least one heat source is arranged on the housing.

9. The traction energy store according to claim 1, further comprising a battery management system (BMS) configured to detect a temperature of the at least one electrochemical secondary cell and, depending upon the detected temperature, to control a current fed from the at least one electrochemical secondary cell of the at least one heat source.

10. The traction energy store according to claim 1, wherein the at least one heat source comprises an electrically operated heating cartridge and/or an electrically operated heating foil.

11. The traction energy store according to claim 1, further comprising an electric power terminal configured to establish an energy exchange with an electric drive train of the motor vehicle.

12. A motor vehicle comprising:
at least one electrochemical secondary cell comprising at least one cell wall;
at least one pressure-tight heat pipe, which is configured for passive transmission of heat from a heat-absorbing end of the at least one pressure-tight heat pipe to a heat-emitting end of the at least one pressure-tight heat pipe, wherein the heat-emitting end is spaced from the heat-absorbing end, using heat of vaporization, wherein the heat-emitting end constitutes part of the at least one cell wall or projects through the at least one cell wall into the at least one electrochemical secondary cell; and
at least one heat source arranged outside the at least one electrochemical secondary cell and in direct contact with the heat-absorbing end of the at least one pressure-tight heat pipe.

13. The motor vehicle according to claim 12, wherein the motor vehicle is a service vehicle.
